(19) United States
(12) Patent Application Publication
(10) Pub. No.: US 2026/0028239 A1
(43) Pub. Date: Jan. 29, 2026

(54) METHOD AND APPARATUS FOR EXTRACTING COPPER/TIN SOURCE MATERIAL FROM OXALATE OF COPPER AND/OR TIN

(71) Applicants: Tao Ye, Guangzhou (CN); Yiting Ye, Guangzhou (CN)

(72) Inventors: Tao Ye, Guangzhou (CN); Yiting Ye, Guangzhou (CN)

(21) Appl. No.: 19/348,855

(22) Filed: Oct. 3, 2025

Related U.S. Application Data
(63) Continuation of application No. PCT/CN2024/085297, filed on Apr. 1, 2024.

(30) Foreign Application Priority Data
Apr. 3, 2023 (CN) 202310346237.4
Nov. 14, 2023 (CN) 202311513355.6
Jan. 26, 2024 (CN) 202410113123.X
Feb. 19, 2024 (CN) 202410184888.2

(51) Int. Cl. C01G 3/02; C01D 1/04; C01D 5/00; C01G 19/00; C22B 3/00; C22B 3/02; C22B 3/22; C22B 3/44; C22B 15/00

(52) U.S. Cl. CPC C01G 3/02; C01D 1/04; C01D 5/00; C01G 19/00; C22B 3/02; C22B 3/22; C22B 3/44; C22B 15/0086; C22B 15/0089; C22B 25/04

(57) ABSTRACT

Provided is a method and apparatus for extracting a copper/tin source material from an oxalate of copper and/or tin. The method includes the following steps: (1) approach 1: allowing cupric oxalate and/or stannous oxalate to undergo a chemical reaction with a hypochlorite in a hypochlorite-containing aqueous solution to produce a copper compound-containing and/or tin compound-containing precipitate, which is accompanied by release of carbon dioxide; and/or approach 2: allowing the cupric oxalate and/or the stannous oxalate to undergo a chemical reaction in a solution including an alkaline substance to produce a copper compound-containing and/or tin compound-containing precipitate, where the alkaline substance includes a potassium-containing alkaline substance; and (2) solid-liquid separating to produce a filter residue A and a filtrate B, where the filter residue A is the copper compound-containing and/or tin compound-containing precipitate.

### CROSS-REFERENCE TO RELATED APPLICATIONS

The present application is a continuation application of PCT application No. PCT/CN2024/085297 filed on Apr. 1, 2024, which claims the benefit of Chinese Patent Application Nos. 202310346237.4 filed on Apr. 3, 2023, 202311513355.6 filed on Nov. 14, 2023, 202410113123.X filed on Jan. 26, 2024, and 202410184888.2 filed on Feb. 19, 2024. The contents of all of the aforementioned applications are incorporated by reference herein in their entirety.

### TECHNICAL FIELD

The present disclosure belongs to the technical field of eco-friendly waste recycling, and specifically relates to a method and apparatus for extracting a copper/tin source material from an oxalate of copper and/or tin.

### BACKGROUND

During etching in a circuit board manufacturing process, the unnecessary copper on the copper-clad laminate is removed with an etching solution through chemical corrosion to form a desired circuit pattern. The common etching solutions include acidic etching solutions and ammonia-alkaline etching solutions. Micro-etching refers to corroding a copper layer with a micro-etching solution for thinning or surface roughening. Both spent etching solutions and spent micro-etching solutions include copper ions resulting from the corrosion of metallic copper. When a circuit pattern pre-designed on the copper-clad laminate is etched with an etching solution, a metallic tin layer is coated on the circuit pattern as an anti-etching layer, and metallic copper on the copper-clad laminate that is not protected by the metallic tin layer is removed by the etching solution through chemical corrosion. After the etching is completed, the metallic tin anti-etching layer on the pre-designed circuit pattern and through-holes needs to be stripped with a nitric acid-based tin-stripping solution, resulting in a spent nitric acid-based tin-stripping solution including tin ions. Such a spent nitric acid-based tin-stripping solution typically further includes a small number of copper ions. The common acidic etching and micro-etching solutions both involve an iron-containing formula and an iron-free formula, such as an acidic cupric chloride-ferric chloride etching solution and an acidic cupric chloride etching solution; a sulfuric acid-hydrogen peroxide micro-etching solution, and a sulfuric acid-ferric sulfate-persulfate mixed micro-etching solution. A tin-containing waste liquid is also generated during the chemical immersion tin process. With the large-scale production, the above processes cause manufacturing enterprises to discharge large amounts of tin and/or copper-containing waste liquids daily.

The existing technologies for recycling spent nitric acid-based tin-stripping solutions or spent chemical immersion tin solutions include a process for recovering metallic tin with oxalic acid and a process for treating a spent acidic etching solution from circuit board production with oxalic acid to produce cupric oxalate and regenerate an etching replenisher. The process for recovering a metal salt from a waste liquid with oxalic acid is specifically as follows: oxalic acid is added to the waste liquid to produce a stannous oxalate and/or cupric oxalate precipitate, and a resulting reaction mixture is subjected to solid-liquid separation to produce stannous oxalate and/or cupric oxalate as a filter residue. When a spent nitric acid-based tin-stripping solution reacts with oxalic acid and then solid-liquid separation is conducted, a resulting filtrate includes nitric acid as the main component. Concentrated nitric acid and an additive can be added to such a filtrate to regenerate a nitric acid-based tin-stripping solution, and the nitric acid-based tin-stripping solution is then reused in a tin-stripping production line. When a spent acidic etching solution reacts with oxalic acid and then solid-liquid separation is conducted, a resulting filtrate includes hydrochloric acid as the main component. Such a filtrate can be subjected to oxalic acid impurity removal and then recycled in an acidic etching production line. When a spent chemical immersion tin solution reacts with oxalic acid and then solid-liquid separation is conducted to recover a tin salt, a resulting filtrate is treated to be eco-friendly and then discharged. The process of recovering a metal salt with oxalic acid is simple and energy-saving and has a high waste recycling rate. Therefore, many circuit board manufacturers have begun to adopt the process of recovering a metal salt with oxalic acid.

Due to the relatively-stable properties of cupric oxalate and stannous oxalate, there are few chemical substances that can react with cupric oxalate and stannous oxalate under mild conditions. Additionally, the applications of cupric oxalate and stannous oxalate are highly limited, resulting in a narrow market scope. Therefore, cupric oxalate and stannous oxalate need to be further converted into an oxide and/or a hydroxide of copper and/or tin, which can be used as a copper/tin source material in a wide variety of industrial processes.

However, currently, the treatment of cupric oxalate and/or stannous oxalate produced from the aforementioned waste liquid treatment processes in the industry predominantly relies on high-temperature decomposition, which requires a reaction temperature of at least 300° C. or higher. The corresponding chemical reactions are as follows:

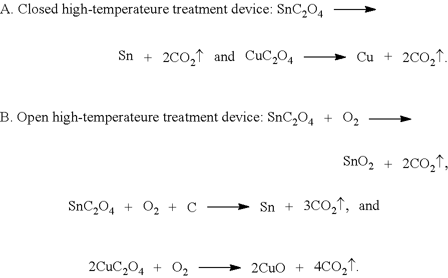

Due to potential hazards such as fire hazards and burn injuries associated with the high-temperature process and the large energy consumption of high-temperature decomposition, most of the circuit board manufacturers are reluctant to adopt high-temperature decomposition for treating an oxalate of copper and/or tin in the original production facility. Therefore, circuit board manufacturers are looking forward to the development of a novel technology that can treat cupric oxalate and/or stannous oxalate at room temperature and ambient pressure to produce a copper material or a tin material, which can guarantee the safe production with low pollution and can also achieve the cost reduction and benefit improvement.

### SUMMARY

A first objective of the present disclosure is to provide a method for extracting a copper/tin source material from an oxalate of copper and/or tin. This method enables a treatment under mild chemical reaction conditions to produce a copper source material and/or a tin source material as raw materials for production. A second objective of the present disclosure is to provide an apparatus for extracting a copper/tin source material from an oxalate of copper and/or tin.

The present disclosure achieves the above objectives through the following technical solutions:

A method for extracting a copper/tin source material from an oxalate of copper and/or tin is provided, including the following steps:

(1) treating the oxalate of copper and/or tin using at least one of the following approaches:
approach 1: allowing cupric oxalate and/or stannous oxalate to undergo a chemical reaction with a hypochlorite in a hypochlorite-containing aqueous solution to produce a copper compound-containing and/or tin compound-containing precipitate, which is accompanied by release of carbon dioxide; and
approach 2: allowing the cupric oxalate and/or the stannous oxalate to undergo a chemical reaction in a solution including an alkaline substance to produce a copper compound-containing and/or tin compound-containing precipitate, where the alkaline substance includes a potassium-containing alkaline substance; and
(2) subjecting a solid-liquid mixture produced after the chemical reaction in the step (1) to solid-liquid separation to produce a filter residue A and a filtrate B, where the filter residue A is the copper compound-containing and/or tin compound-containing precipitate.

In the step (1), the stannous oxalate is produced from a reaction of a tin-containing waste liquid with oxalic acid or a reaction of oxalic acid with a filtrate produced by filtering the tin-containing waste liquid to remove a stannic oxide solid. The cupric oxalate is produced by adding oxalic acid to a copper-containing waste liquid, primarily a spent acidic etching solution or a spent micro-etching solution from circuit board production. The cupric oxalate and the stannous oxalate are both insoluble substances, and thus can be separated from a reaction solution through solid-liquid separation.

In the approach 1 of the step (1), the hypochlorite serves as an oxidizing agent, and is sodium hypochlorite and/or potassium hypochlorite. In the approach 2 of the step (1), the potassium-containing alkaline substance is one or more selected from the group consisting of potassium hydroxide, potassium carbonate, and potassium bicarbonate.

In the step (2), the filter residue A is an oxide and/or a hydroxide of tin and/or copper. The filter residue A can be directly reused as a production raw material. Alternatively, depending on technical requirements of a recycling process, metallic tin, a tin salt, metallic copper, cupric oxide, cuprous oxide, and a copper salt can be selectively prepared accordingly and then utilized as a production raw material. For example, the tin salt, the copper salt, and the cupric oxide can be reused in an electroplating production line.

In the approach 1 of the step (1), when an oxalate group in stannous oxalate and/or cupric oxalate is oxidized by sodium hypochlorite and/or potassium hypochlorite, the following oxidation-reduction reactions occur:

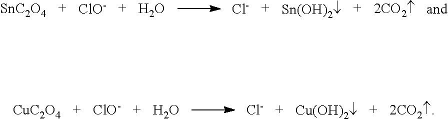

Therefore, in the approach 1, a tin compound-containing precipitate produced is stannous hydroxide. When a pH of a reaction solution is high, stannous hydroxide is converted into stannous oxide. Moreover, when stannous hydroxide and stannous oxide are soaked in a reaction solution including excessive hypochlorite, stannic oxide SnO₂ is generated. In the approach 1, a copper compound-containing precipitate produced is cupric hydroxide. When a pH of a reaction solution is high, cupric hydroxide is converted into cupric oxide. Therefore, when the approach 1 is adopted, in the step (2), a main component of the filter residue A is at least one selected from the group consisting of stannous hydroxide, cupric hydroxide, stannous oxide, stannic oxide, and cupric oxide, and the filtrate B is a chloride salt-containing solution, which is treated for environmental protection and then discharged.

During the chemical reaction in the approach 1, proportions of cupric hydroxide and cupric oxide in a product vary with various process factors such as a pH of a reaction solution, a reaction time, and a temperature of a reaction solution. The higher the pH and temperature of the reaction solution, the more likely the produced copper compound-containing precipitate is to be cupric oxide. Therefore, based on practical experience, an appropriate reaction temperature and pH can be determined by detecting a composition of a copper compound-containing precipitate. Preferably, in the approach 1, to ensure that the copper compound-containing precipitate primarily includes cupric hydroxide, a pH of a reaction solution should be controlled in a range of 3.5≤pH≤8.5 during the chemical reaction. Preferably, in the approach 1, to ensure that the copper compound-containing precipitate primarily includes cupric oxide, the pH of the reaction solution should be controlled at 10 or higher during the chemical reaction.

An oxidizing agent used for the chemical reaction in the approach 1 is preferably a sodium hypochlorite solution for cost reduction.

Preferably, in the approach 1, during an oxidation process, an oxidation-reduction potential (ORP) meter is used to control addition of the hypochlorite, or a pH meter and the ORP meter are used to control addition of a pH adjusting agent and the hypochlorite, respectively, such that the reaction solution undergoes the chemical reaction in a direction of generating a process-defined target product under stably-controlled parameters. The pH adjusting agent is preferably one or more selected from the group consisting of sodium hydroxide, potassium hydroxide, sodium carbonate, potassium carbonate, sodium bicarbonate, and potassium bicarbonate.

In the approach 2 of the step (1), when stannous oxalate and/or cupric oxalate is mixed with a solution including the potassium-containing alkaline substance for a reaction, at least one of the following chemical reactions primarily occurs:

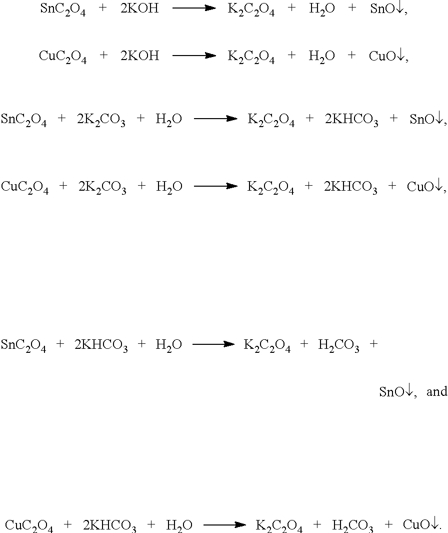

In the approach 2 of the step (1), the alkaline substance is either the potassium-containing alkaline substance alone or a mixture of the potassium-containing alkaline substance and a sodium-containing alkaline substance. The sodium-containing alkaline substance is one or more selected from the group consisting of sodium hydroxide, sodium carbonate, and sodium bicarbonate. Preferably, the alkaline substance is potassium hydroxide or a mixture of potassium hydroxide and sodium hydroxide. More preferably, the alkaline substance is potassium hydroxide.

Therefore, when the approach 2 is adopted, in the step (2), the filter residue A includes stannous oxide and/or cupric oxide as a main component, and the filtrate B includes potassium oxalate or a mixture of potassium oxalate and sodium oxalate as a main component, which can be reused as a raw material for other production.

When the alkaline substance in the approach 2 includes a sodium-containing alkaline substance, namely, sodium hydroxide and/or sodium carbonate and/or sodium bicarbonate, sodium oxalate will be generated. Due to the low solubility of sodium oxalate, when a large amount of sodium oxalate is generated in a reaction solution, saturation will be reached and a sodium oxalate solid will be precipitated in the reaction solution, resulting in co-precipitation with stannous oxide and/or cupric oxide. Although most of sodium oxalate impurities can be removed by washing stannous oxide and/or cupric oxide with water subsequently, stannous oxide and/or cupric oxide is encapsulated by sodium oxalate during the co-precipitation, which not only increases the treatment procedures, but also complicates the purification of a copper or tin source material. Therefore, in the approach 2 of the step (1), the use of the sodium-containing alkaline substance alone for the chemical reaction should be avoided to avoid the excessive generation of sodium oxalate, thereby preventing the co-precipitation of excessive sodium oxalate with stannous oxide and/or cupric oxide. In addition, the use of the sodium-containing alkaline substance alone will result in a low concentration of sodium oxalate in a filtrate produced after solid-liquid separation due to the low solubility of sodium oxalate, which reduces the recycling value of an oxalate material in the filtrate.

In contrast, potassium oxalate has high solubility and is not easily precipitated during a reaction. Therefore, when the alkaline substance is partially or totally the potassium-containing alkaline substance in the approach 2, there are the following advantages: (1) A water-washing work for stannous oxide and/or cupric oxide can be relieved. (2) Stannous oxide and/or cupric oxide can be effectively prevented from being encapsulated by sodium oxalate. (3) A filtrate produced after solid-liquid separation has a high oxalate content, and thus possesses a high recycling value.

In the approach 2 of the step (1), when the mixture of the potassium-containing alkaline substance and the sodium-containing alkaline substance is used in the chemical reaction, a concentration of a sodium ion in a reaction solution does not exceed preferably 2 mol/L and more preferably 1 mol/L.

In the approach 2 of the step (1), when the cupric oxalate and/or the stannous oxalate is allowed to undergo the chemical reaction in the solution including the alkaline substance, preferably, a temperature of a reaction solution is controlled in a range of 30° C. to 100° C., and/or a pH of the reaction solution is adjusted to 10 or higher during the chemical reaction. The above preferred conditions can accelerate the chemical reaction in the approach 2.

The present disclosure can be improved as follows: When the oxalate participating in a reaction of the step (1) is a mixture of stannous oxalate and cupric oxalate, a copper compound and a tin compound in the filter residue A are separated based on the characteristic that hydroxides of copper and tin are precipitated under different pH values in a metal salt-containing solution. The filter residue A is first dissolved in an acidic solution to produce an acidic mixed solution including a tin salt and a copper salt. An alkaline compound is added to the acidic mixed solution including the tin salt and the copper salt to adjust a pH to control precipitation of a stannous hydroxide solid based on a low pH for precipitation of stannous hydroxide, and the stannous hydroxide solid is separated from a resulting acidic copper salt-containing solution through solid-liquid separation. The acidic solution is a solution including at least one selected from the group consisting of hydrochloric acid, sulfuric acid, and formic acid and preferably including sulfuric acid. Preferably, the alkaline compound is at least one selected from the group consisting of sodium hydroxide, sodium carbonate, sodium bicarbonate, potassium hydroxide, potassium carbonate, and potassium bicarbonate. A suitable pH value range for the separation of the stannous hydroxide from the acidic copper salt-containing solution is 0.9 to 4.17 and preferably 2 to 3.2.

The acidic copper salt-containing solution left after the tin salt is removed from the acidic mixed solution including the tin salt and the copper salt is a mixed solution including a non-heavy metal salt and a copper salt. To produce a pure copper source material, the alkaline compound is further added to the acidic copper salt-containing solution until a pH value is higher than 3.5 to produce a cupric hydroxide and/or cupric oxide precipitate. A resulting reaction mixture is subjected to solid-liquid separation to obtain a cupric hydroxide and/or cupric oxide-containing filter residue and a filtrate. The filtrate is treated for environmental protection.

The present disclosure can be improved as follows: When the approach 2 in the step (1) is adopted, the filtrate B obtained in the step (2) is further mixed with a compound including at least one selected from the group consisting of calcium, manganese, zinc, and ferrous iron for a reaction to produce a desired oxalate product based on a market demand. Preferably, the compound is one or more selected from the group consisting of a ferrous salt, a calcium salt, and calcium hydroxide. More preferably, the compound is ferrous sulfate or calcium hydroxide. With reactions of potassium oxalate with a ferrous salt, a manganese salt, a calcium salt, calcium hydroxide, and a zinc salt as examples, chemical equations for the above reaction are as follows:

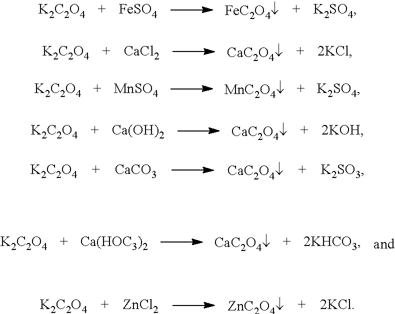

When ferrous sulfate is mixed with the filtrate B for the reaction, a high-value ferrous oxalate product and a potassium sulfate fertilizer product with high market demand can be produced to improve the economic benefits of production. When one or more selected from the group consisting of calcium hydroxide, calcium carbonate, and calcium bicarbonate is mixed with the filtrate B, a calcium oxalate product can be generated, and a regenerated alkaline substance can be reused in the next round of cupric oxalate and/or stannous oxalate treatment, which achieves the recycling and is eco-friendly and cost-saving.

In the step (1), when a substance to be treated includes stannous oxalate, with the approach 1 and/or the approach 2, a high alkalinity of a reaction solution will lead to the generation of a soluble stannate due to the amphoteric nature of tin, which reduces the yield of a tin compound-containing precipitate. Preferably, in the step (1), a pH of a reaction solution for treating stannous oxalate is lower than or equal to 14 to avoid the generation of a soluble stannate.

The present disclosure can be improved as follows: The filter residue A is washed with water to produce a pure hydroxide and/or oxide of tin and/or copper, which reduces the impurity content and facilitates the use. A waste liquid resulting from the washing of the filter residue A is treated for environmental protection and then discharged.

The present disclosure can also be improved as follows: A hypochlorite solution is prepared with chlorine generated from electrolysis of a spent acidic etching solution, and used in the chemical reaction of the approach 1 in the step (1). Specifically, the spent acidic etching solution is subjected to the electrolysis, chlorine is generated at an electrolysis anode, and the produced chlorine is introduced into an alkaline solution to prepare the hypochlorite. In the prior art, the spent acidic etching solution is subjected to electrolytic oxidation with an electrolytic cell to produce chlorine, or simultaneously, metallic copper is deposited at an electrolysis cathode. This improvement not only achieves the cost reduction, but also enables the consumption of excessive chlorine generated during the electrolysis. Preferably, the alkaline solution includes at least one alkaline compound selected from the group consisting of sodium hydroxide, potassium hydroxide, sodium carbonate, potassium carbonate, sodium bicarbonate, and potassium bicarbonate. A chemical reaction principle for the preparation of the hypochlorite described above is as follows:

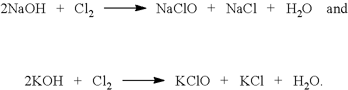

Preferably, the cupric oxalate is first directly added to a reaction tank with the alkaline solution for producing the hypochlorite, an amount of the chlorine introduced into the reaction tank is controlled by an ORP meter arranged in the reaction tank, and an amount of the alkaline compound is controlled to maintain a desired pH value of a reaction solution, such that a reaction product is primarily CuO to produce a cupric oxide powder product. The corresponding chemical reactions are as follows:

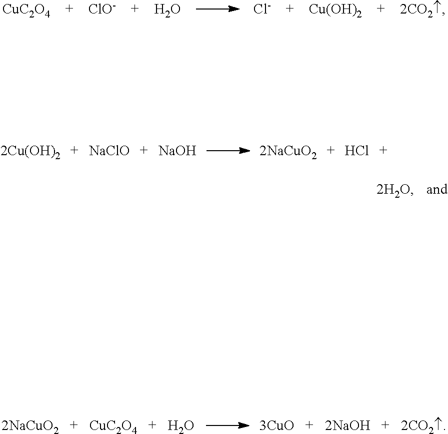

The present disclosure can also be improved as follows: A cupric oxalate precipitate produced from a reaction of an iron-containing acidic etching solution with oxalic acid needs to be washed with hydrochloric acid and/or sulfuric acid at least once to remove iron. Preferably, hydrogen peroxide is added to an acid-washing solution for the cupric oxalate to reduce the generation of ferrous oxalate. When cupric oxalate is produced from an iron-containing acidic etching solution, a resulting cupric oxalate-containing filter residue obtained after solid-liquid separation includes an iron salt, and thus the cupric oxalate-containing filter residue is washed with hydrochloric acid and/or sulfuric acid to remove the iron salt. With an acidic cupric chloride-ferric chloride etching solution as an example, the following chemical reactions occur:

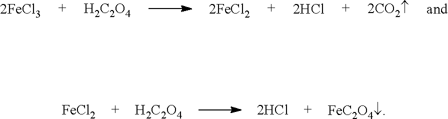

Therefore, a cupric oxalate product obtained from a reaction of the acidic cupric chloride-ferric chloride etching solution with oxalic acid includes ferrous oxalate and ferric chloride impurities. Similarly, when cupric oxalate is produced from a mixed micro-etching solution including sulfuric acid, ferric sulfate, cupric sulfate, and a persulfate, a resulting cupric oxalate-containing filter residue includes a ferric sulfate impurity.

The present disclosure also provides an apparatus for extracting a copper/tin source material from an oxalate of copper and/or tin, including: at least one hypochlorite-based reaction tank and/or at least one alkaline solution-based reaction tank, and at least one solid-liquid separator.

The at least one hypochlorite-based reaction tank is configured to enable the chemical reaction of the cupric oxalate and/or the stannous oxalate with the hypochlorite in the step (1) to primarily produce stannous hydroxide and/or cupric hydroxide and/or cupric oxide. The at least one alkaline solution-based reaction tank is configured to enable the chemical reaction of the cupric oxalate and/or the stannous oxalate with a solution including the potassium-containing alkaline substance in the step (1) to primarily produce stannous oxide and/or cupric oxide.

The at least one solid-liquid separator is configured to enable the solid-liquid separation for the solid-liquid mixture. The at least one solid-liquid separator is at least one selected from the group consisting of a filter press, a centrifuge, and a filter.

The present disclosure can be improved as follows: The at least one alkaline solution-based reaction tank is provided with a heat exchanger, and the heat exchanger is specifically a heater. That is, an alkaline solution-based reaction tank with a heater is provided. The heater is configured to enable the chemical reaction of the cupric oxalate and/or the stannous oxalate with the solution including the potassium-containing alkaline substance under heating to rapidly produce the stannous oxide and/or the cupric oxide.

The present disclosure can also be improved as follows: The at least one hypochlorite-based reaction tank is further provided with a pH meter and/or an ORP meter to make a reaction proceed in a direction of generating a target product.

The present disclosure can also be improved as follows: A washing tank is further provided to wash iron-containing cupric oxalate and/or a filter residue including a compound of copper and/or tin produced after a reaction to produce pure cupric oxalate or pure stannous hydroxide, cupric hydroxide, stannous oxide, and cupric oxide.

The present disclosure can also be improved as follows: A temporary storage tank is further provided to temporarily store a material.

The present disclosure can also be improved as follows: A standard chemical reaction tank is further provided to prepare a solution.

The present disclosure can also be improved as follows: A stirrer is further provided for the at least one hypochlorite-based reaction tank and/or the at least one alkaline solution-based reaction tank and/or the standard chemical reaction tank to thoroughly stir a solution. The stirrer is structurally classified as an impeller stirrer and a liquid flow pump pipe stirrer.

The present disclosure can also be improved as follows: A heat exchanger is further provided for the at least one hypochlorite-based reaction tank and/or the standard chemical reaction tank to control a reaction solution at a desired temperature.

The present disclosure can also be improved as follows: A tail gas treatment unit is further provided to treat a tail gas discharged from each tank for environmental protection.

The present disclosure can also be improved as follows: Sensors and an automatic detection and feeding controller are further provided to enable automatic program control through data acquisition and processing during production. A sensing signal input terminal of the automatic detection and feeding controller is connected to sensing signal output terminals of the sensors, and a control signal output terminal of the automatic detection and feeding controller is connected to control signal input terminals of the heater, the heat exchanger, the stirrer, a valve, and a pump in the apparatus. The sensors include a thermometer, a liquid level meter, an acidity meter, a pH meter, a gravimeter, an ORP meter, and a chlorine gas concentration detector.

The present disclosure can also be improved as follows: An electric furnace is further provided to oven-dry a powdered product produced after the solid-liquid separation.

The present disclosure can also be improved as follows: An overflow buffer tank is further provided to address issues caused by an unsmooth liquid flow between tanks in the apparatus.

The present disclosure can also be improved as follows: An electrolytic cell is further provided to prepare a hypochlorite solution with chlorine produced from electrolysis with a spent acidic etching solution as an electrolyte. The electrolytic cell is provided with a separator to divide the electrolytic cell into an anode compartment and a cathode compartment. A function of the separator is to facilitate the collection and utilization of chlorine generated at an electrolysis anode.

Compared with the prior art, the present disclosure has the following beneficial effects:

1. The method of the present disclosure abandons the conventional high-temperature decomposition for treating cupric oxalate and/or stannous oxalate in the prior art, and adopts mild chemical reaction conditions instead. As a result, enterprises are more inclined to prepare a tin or copper source material using stannous oxalate and/or cupric oxalate from a waste liquid on the production site, or even reuse the tin or copper source material in production procedures of the enterprises, which significantly reduces the production cost. Compared to the existing high-temperature decomposition process, the method of the present disclosure can greatly enhance the production safety and reduce the energy consumption.

2. In the present disclosure, a hypochlorite solution can be prepared with chlorine generated from the electrolysis of a spent acidic etching solution for electrolytic copper extraction, which reduces the treatment cost for producing a tin or copper source material.

3. In the method of the present disclosure, no additional pollution source is introduced during a treatment, which complies with the environmentally-friendly production requirement.

4. The method of the present disclosure involves safe, reliable, and simple operations, a small equipment investment, and a low operational management cost.

5. In the present disclosure, an oxalate group in stannous oxalate or cupric oxalate can be converted to produce other oxalate products, thereby achieving the maximum material utilization and reducing the environmental pollution and energy consumption.

### BRIEF DESCRIPTION OF THE DRAWINGS

FIG. 1 is a schematic diagram of an apparatus and method for extracting a copper/tin source material from an oxalate of copper and/or tin in Example 1 of the present disclosure;

FIG. 2 is a schematic diagram of an apparatus and method for extracting a copper/tin source material from an oxalate of copper and/or tin in Example 2 of the present disclosure;

FIG. 3 and FIG. 4 constitute a schematic diagram of an apparatus and method for extracting a copper/tin source material from an oxalate of copper and/or tin in Example 3 of the present disclosure, where FIG. 3 shows a left portion of the apparatus and FIG. 4 shows a right portion of the apparatus;

FIG. 5, FIG. 6, and FIG. 7 constitute a schematic diagram of an apparatus and method for extracting a copper/tin source material from an oxalate of copper and/or tin in Example 4 of the present disclosure;

FIG. 8 and FIG. 9 constitute a schematic diagram of an apparatus and method for extracting a copper/tin source material from an oxalate of copper and/or tin in Example 5 of the present disclosure, where FIG. 8 shows a left portion of the apparatus and FIG. 9 shows a right portion of the apparatus;

FIG. 10 and FIG. 11 constitute a schematic diagram of an apparatus and method for extracting a copper/tin source material from an oxalate of copper and/or tin in Example 6 of the present disclosure;

FIG. 12 is a schematic diagram of an apparatus and method for extracting a copper/tin source material from an oxalate of copper and/or tin in Example 7 of the present disclosure;

FIG. 13 is a schematic diagram of an apparatus and method for extracting a copper/tin source material from an oxalate of copper and/or tin in Example 8 of the present disclosure; and

FIG. 14 is a schematic diagram of an apparatus and method for extracting a copper/tin source material from an oxalate of copper and/or tin in Example 9 of the present disclosure.

### REFERENCE NUMERALS

1—hypochlorite-based reaction tank, 2—alkaline solution-based reaction tank, 3—standard chemical reaction tank, 4—washing tank, 5—solid-liquid separator, 6—temporary storage tank, 7—impeller stirrer, 8—liquid flow pump pipe stirrer, 9—heat exchanger, 10—tail gas treatment unit, 11—sensor, 12—automatic detection and feeding controller, 13—tin-containing and/or copper-containing waste liquid, 14—cupric oxalate-stannous oxalate solid mixture, 15—cupric oxalate, 16—stannous oxalate, 17—oxalic acid, 18—solution primarily including a soluble oxalate, 19—crude stannous hydroxide, 20—crude cupric hydroxide, 21—crude stannous oxide, 22—crude cupric oxide, 23—pure stannous hydroxide, 24—pure stannous oxide, 25—pure cupric hydroxide, 26—pure cupric oxide, 27—acidic solution, 28—alkaline solution, 29—immersion tin plating solution, 30—chemical tin plating solution, 31—acidic tin electroplating solution, 32—chemical immersion tin production line, 33—water, 34—pure hydrochloric acid, 35—pure sulfuric acid, 36—stannous chloride solution, 37—stannous sulfate solution, 38—metallic tin block, 39—tin plating component, 40—other raw materials for preparing the immersion tin plating solution, 41—other raw materials for preparing the chemical tin plating solution, 42—other raw materials for preparing the acidic tin electroplating solution, 43—salt-containing waste liquid, 44—hypochlorite solution, 45—valve, 46—pump, 47—electric furnace, 48—carbon dioxide, 49—sealing tank cover, 50—spray tower, 51—vacuum ejector, 52—overflow buffer tank, 53—mixture of tin and copper compounds that has a low impurity content, 54—acidic cupric chloride etching line, 55—acidic tin electroplating production line, 56—electrolytic cell, 57—separator, 58—electrolysis anode, 59—electrolysis cathode, 60—electrolytic power supply, 61—spent acidic cupric chloride etching solution, 62—sodium cuprate, 63—metallic copper, 64—evaporator, 65—potassium oxalate solid, 66—calcium hydroxide, 67—ferrous sulfate, 68—calcium oxalate, 69—ferrous oxalate, 70—potassium sulfate, 71—iron impurity-containing cupric oxalate, 72—hydrogen peroxide, 73—sodium oxalate solid, and 74—alkaline substance solid.

### DETAILED DESCRIPTION OF THE EMBODIMENTS

The present disclosure will be further described below through specific embodiments.

In the embodiments of the present disclosure, an 800 L hypochlorite-based reaction tank, an 800 L alkaline solution-based reaction tank, an 800 L standard chemical reaction tank, and a 1,000 L washing tank are adopted, and these tanks and a tail gas treatment unit are all products of Yegao Environmental Protection Equipment Manufacturing Co., Ltd. in Foshan City, Guangdong Province, China. A solid-liquid separator, a 2,000 L temporary storage tank, a chemical immersion tin production line, a tin electroplating production line, an acidic cupric chloride etching line, a stirrer, a sensor, an automatic program controller, a heat exchanger, an electric furnace, a valve, a pump, and a chemical raw material are all commercially-available products. Stannous oxalate and cupric oxalate to be treated are produced by adding oxalic acid to a tin-containing and/or copper-containing waste liquid for a reaction. Other products with similar properties to the products listed above in the present disclosure may also be adopted by those skilled in the art according to conventional selection, which all can achieve the objectives of the present disclosure.

### Example 1

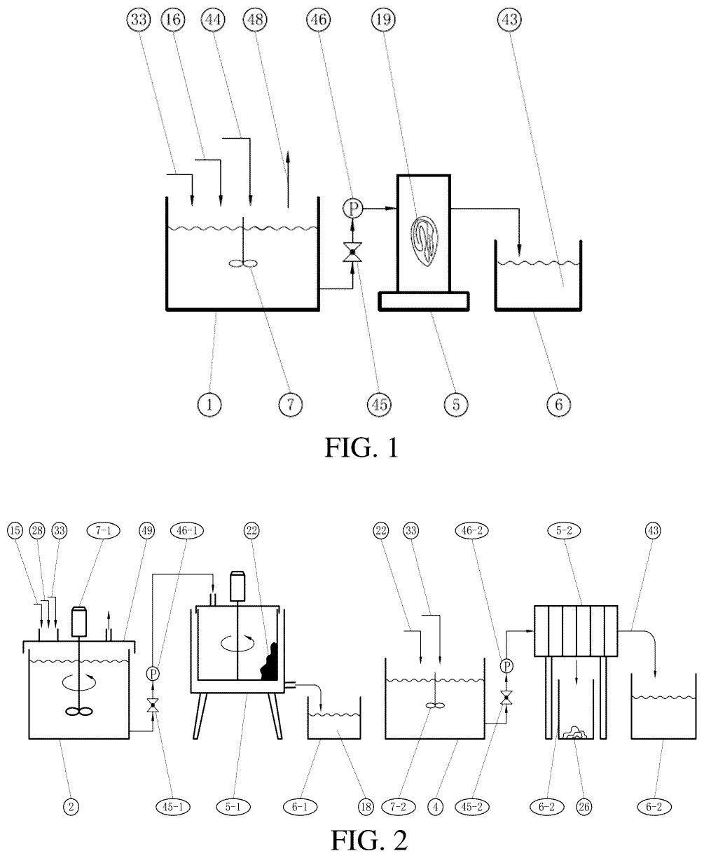

As shown in FIG. 1, an apparatus for extracting a copper/tin source material from an oxalate of copper and/or tin is provided in Example 1, including a hypochlorite-based reaction tank 1, a solid-liquid separator 5, a temporary storage tank 6, an impeller stirrer 7, a valve, and a pump.

The hypochlorite-based reaction tank 1 is connected to the solid-liquid separator 5. The solid-liquid separator 5 is a filter, and is further connected to the temporary storage tank 6.

In this example, a substance to be treated is stannous oxalate 16. A hypochlorite solution 44 adopted is a mixed solution of sodium hypochlorite and potassium hypochlorite. The hypochlorite solution has a hypochlorite concentration of 9%, a pH of 14, and a specific gravity of 1.069 g/mL.

In this example, a method for extracting a copper/tin source material from an oxalate of copper and/or tin is provided, including the following steps:

1. A specified amount of water and 20 kg of stannous oxalate 16 were added to the hypochlorite-based reaction tank 1. Then, the hypochlorite solution 44 was slowly added to react with the stannous oxalate. An amount of a hypochlorite added was 1.1 times an equivalent amount required to react with the stannous oxalate. The impeller stirrer 7 in the hypochlorite-based reaction tank 1 was started, and a chemical reaction was conducted for 1 h to produce a tin compound-containing precipitate.

2. The pump 46 was started to enable solid-liquid separation for a reaction product in the hypochlorite-based reaction tank 1 by the solid-liquid separator 5 to produce a filter residue A and a filtrate B. The filter residue A was primarily crude stannous hydroxide 19, which was retained in the filter. The filtrate B was a salt-containing waste liquid 43. After the chemical reaction was completed, a stannous hydroxide product was collected.

3. During a filtration process, the salt-containing waste liquid 43 was diverted to the temporary storage tank 6 for temporary storage.

Through the above steps, the stannous oxalate was converted into the stannous hydroxide product through the chemical reaction in the approach 1 of the present disclosure.

### Example 2

As shown in FIG. 2, an apparatus for extracting a copper/tin source material from an oxalate of copper and/or tin is provided in Example 2 of the present disclosure, including an alkaline solution-based reaction tank 2, a washing tank 4, two solid-liquid separators 5, two temporary storage tanks 6, two impeller stirrers 7, a valve, and a pump.

The alkaline solution-based reaction tank 2 is connected to a solid-liquid separator 5-1, and the washing tank 4 is connected to a solid-liquid separator 5-2. The two solid-liquid separators are further connected to respective temporary storage tanks. A top of the alkaline solution-based reaction tank 2 is provided with a sealing tank cover 49.

The solid-liquid separator 5-1 is a centrifuge, and the solid-liquid separator 5-2 is a filter press.

An impeller stirrer 7-1 is arranged in the alkaline solution-based reaction tank 2, and an impeller stirrer 7-2 is arranged in the washing tank 4.

In this example, a substance to be treated is cupric oxalate 15. An alkaline solution 28 is a mixed solution of sodium hydroxide, potassium hydroxide, sodium carbonate, potassium carbonate, sodium bicarbonate, and potassium bicarbonate. The alkaline solution has a specific gravity of 1.3 g/mL.

In this example, a method for extracting a copper/tin source material from an oxalate of copper and/or tin is provided, including the following steps:

1. A specified amount of water and 20 kg of the cupric oxalate 15 were added to the alkaline solution-based reaction tank 2. Then, the alkaline solution 28 was added until a weight of an alkaline substance was more than twice an equivalent amount required to react with the cupric oxalate and a concentration of sodium ions in a resulting reaction solution was 1 mol/L. The impeller stirrer 7-1 was started, and a chemical reaction was conducted for 24 h at room temperature to produce a precipitate, which was primarily a mixture of crude cupric oxide 22 and sodium oxalate.

2. The pump 46-1 was started to enable solid-liquid separation for a reaction product in the alkaline solution-based reaction tank 2 by the solid-liquid separator 5-1 to produce a filter residue A and a filtrate B. The filter residue A was the mixture of crude cupric oxide 22 and sodium oxalate. The filtrate B was primarily a soluble oxalate-containing solution 18. The filtrate B was diverted to a temporary storage tank 6-1 for temporary storage.

3. The mixture of crude cupric oxide 22 and sodium oxalate was washed with water by the washing tank 4 to remove the sodium oxalate impurity. Solid-liquid separation was conducted by the solid-liquid separator 5-2 to produce pure cupric oxide 26 and a salt-containing waste liquid 43.

Through the above steps, the cupric oxalate was converted into a cupric oxide product through the chemical reaction in the approach 2 of the present disclosure. A solution in the temporary storage tank 6-1 was a mixed solution with an alkaline substance and an oxalate as main components.

### Example 3

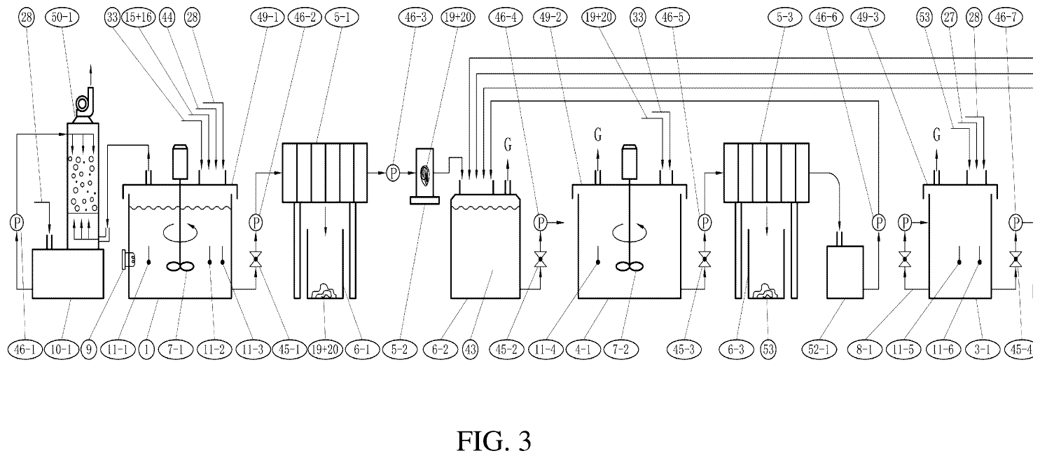

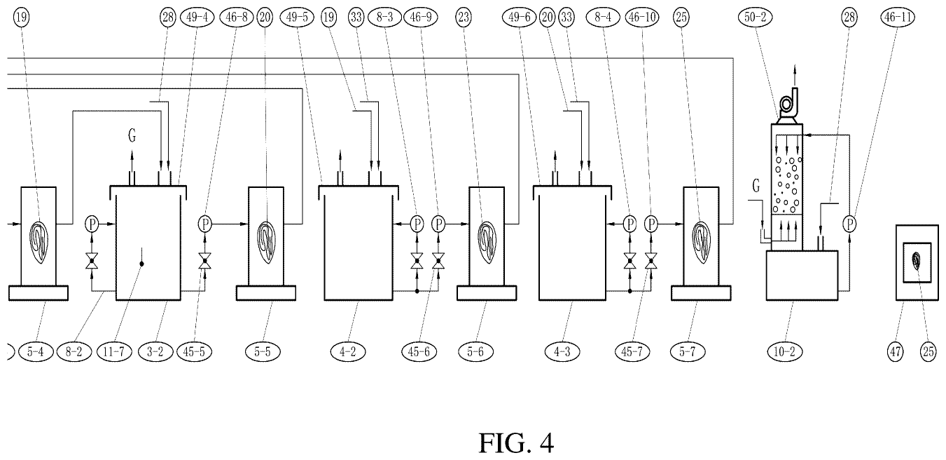

As shown in FIG. 3 and FIG. 4, an apparatus for extracting a copper/tin source material from an oxalate of copper and/or tin is provided in Example 3, including a hypochlorite-based reaction tank 1, two standard chemical reaction tanks 3, three washing tanks 4, seven solid-liquid separators 5, three temporary storage tanks 6, two impeller stirrers 7, four liquid flow stirrers 8, a heat exchanger 9, two tail gas treatment units 10, seven sensors 11, an electric furnace 47, and a plurality of valves and pumps.

The hypochlorite-based reaction tank 1 is connected to a solid-liquid separator 5-1 and a solid-liquid separator 5-2 successively. The solid-liquid separator 5-2 is further connected to a temporary storage tank 6-2 through a liquid pipeline. A temporary storage tank 6-1 is configured to load a filter residue separated by the solid-liquid separator 5-1. The temporary storage tank 6-2 is connected to a washing tank 4-1 through a solid-liquid separator 5-3 and an overflow buffer tank 52-1 for circulation. A temporary storage tank 6-3 is configured to load a filter residue separated by the solid-liquid separator 5-3, which is specifically a mixture 53 of tin and copper compounds that has a low impurity content.

A standard chemical reaction tank 3-1 is connected to a standard chemical reaction tank 3-2 through a solid-liquid separator 5-4, and the standard chemical reaction tank 3-2 is connected to the temporary storage tank 6-2 through a solid-liquid separator 5-5.

Washing tanks 4-2 and 4-3 are both connected to respective solid-liquid separators, and then connected to the temporary storage tank 6-2.

A top of each reaction tank in the apparatus is provided with a sealing tank cover.

An impeller stirrer and a heat exchanger are arranged in the hypochlorite-based reaction tank 1.

The solid-liquid separators 5-1 and 5-3 are filter presses, and the solid-liquid separators 5-2, 5-4, 5-5, 5-6, and 5-7 are filters.

The apparatus of this example is further provided with the electric furnace 47 and tail gas treatment units 10-1 and 10-2.

The electric furnace 47 is configured to heat-dry cupric hydroxide to remove moisture.

The tail gas treatment unit 10-1 is specifically configured to treat an oxidizing tail gas escaping from the hypochlorite-based reaction tank 1. The tail gas treatment unit 10-2 is configured to treat tail gases escaping from the three standard chemical reaction tanks 3 in the apparatus.

A sensor 11-1 is an ORP meter, a sensor 11-2 is a pH meter, and a sensor 11-3 is a thermometer, which are arranged in the hypochlorite-based reaction tank 1. A sensor 11-4 is a liquid level meter arranged in the washing tank 4-1. A sensor 11-5 is a liquid level meter and a sensor 11-6 is a pH meter, which are arranged in the standard chemical reaction tank 3-1. A sensor 11-7 is a pH meter arranged in the standard chemical reaction tank 3-2.

A hypochlorite solution 44 adopted in this example is a sodium hypochlorite solution with a concentration of 9% and a pH of 14. An acidic substance 27 is a mixture of sulfuric acid, hydrochloric acid, and formic acid. An alkaline solution 28, which also serves as a pH adjusting agent, is a sodium hydroxide solution.

A substance to be treated in this example is a mixture 14 of stannous oxalate and cupric oxalate.

In this example, a method for extracting a copper/tin source material from an oxalate of copper and/or tin is provided, including the following steps:

1. 20 kg of the mixture 14 of stannous oxalate and cupric oxalate and a specified amount of water 33 were added to the hypochlorite-based reaction tank 1. A temperature of a reaction solution was controlled at 30° C. by the thermometer. The addition of the sodium hypochlorite solution was controlled by the ORP meter based on a set ORP value of 700 mV. The addition of the alkaline substance 28 was controlled by the pH meter based on a set pH value of 8 to maintain a pH of 8. A reaction was conducted for 3 h to produce a copper and tin compound-containing precipitate.

2. A pump 46-2 was started to enable solid-liquid separation for a mixture in the hypochlorite-based reaction tank 1 through the solid-liquid separator 5-1 and the solid-liquid separator 5-2 to produce a filter residue A and a filtrate. The filter residue A was a mixture of crude stannous hydroxide 19 and crude cupric hydroxide 20. The filtrate was a salt-containing waste liquid, and was diverted to the temporary storage tank 6-2 for temporary storage.

3. The filter residue A in the temporary storage tank 6-1 and the solid-liquid separator 5-2 was transferred to the washing tank 4-1, and washed with water 33. After the washing was completed, solid-liquid separation was conducted with the solid-liquid separator 5-3 to produce a filter residue and a washing salt-containing waste liquid. The filter residue was a mixture of tin and copper compounds that had a low impurity content. The filter residue C was stored in the temporary storage tank 6-3. The washing salt-containing waste liquid was diverted to the temporary storage tank 6-2 for temporary storage through the overflow buffer tank 52-1.

4. The filter residue obtained in the previous step was transferred to the standard chemical reaction tank 3-1. Under the control of a pH meter, the acidic solution 27 was added to adjust a pH of a reaction solution to 0.2. A reaction was conducted for 10 min. Then, the alkaline solution 28 was added to maintain a pH of 3 for 0.5 h to produce a stannous hydroxide precipitate.

5. A mixture in the standard chemical reaction tank 3-1 was subjected to solid-liquid separation with the solid-liquid separator 5-4 to produce crude stannous hydroxide 19 and an acidic copper salt-containing solution. The acidic copper salt-containing solution was diverted to the standard chemical reaction tank 3-2, and the alkaline solution was further added to control a pH of a reaction solution at 7 to produce a cupric hydroxide precipitate.

6. A mixture in the standard chemical reaction tank 3-2 was subjected to solid-liquid separation with the solid-liquid separator 5-5 to produce crude cupric hydroxide 20 and a salt-containing waste liquid after a reaction. The salt-containing waste liquid after the reaction was diverted to the temporary storage tank 6-2 for a later treatment.

7. The crude stannous hydroxide 19 and the crude cupric hydroxide 20 were transferred to the washing tank 4-2 and the washing tank 4-3, respectively, and washed with water. After the washing was completed, solid-liquid separation was conducted with the solid-liquid separators 5-6 and 5-7 to produce pure stannous hydroxide 23 and pure cupric hydroxide 25, respectively. Salt-containing waste liquids after washing were both diverted to the temporary storage tank 6-2 for a centralized treatment.

8. The pure cupric hydroxide 25 was placed in the electric furnace 47, and heat-dried to remove moisture.

Through the above steps, the mixture of cupric oxalate and stannous oxalate was converted into cupric oxide and stannous hydroxide products through chemical reactions.

### Example 4

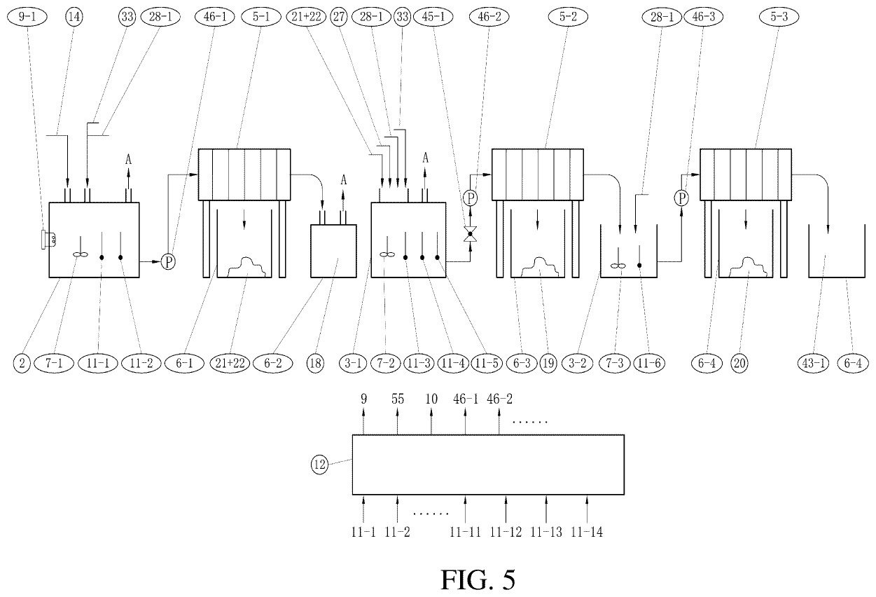

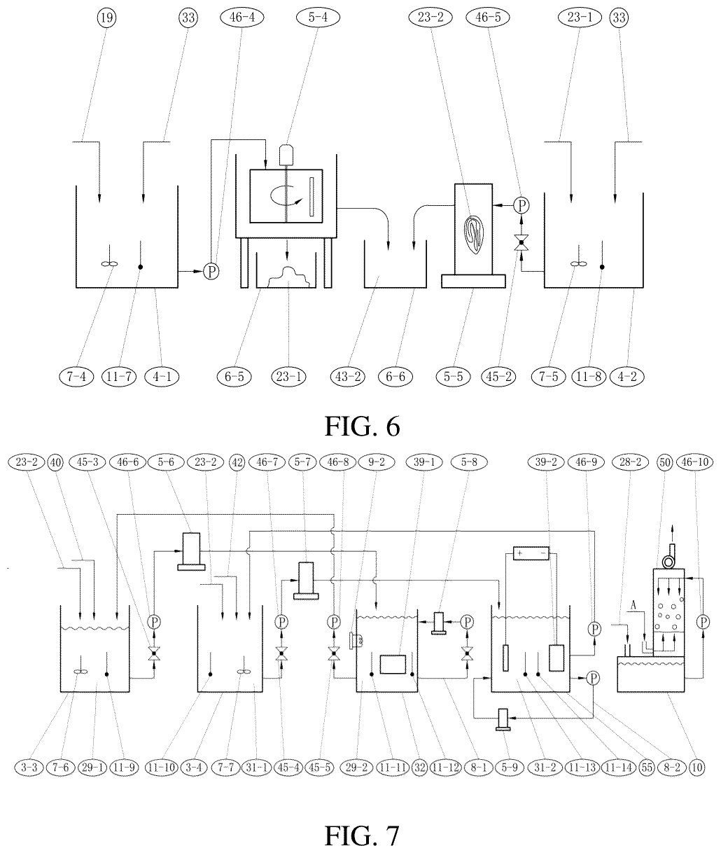

As shown in FIG. 5, FIG. 6, and FIG. 7, an apparatus for extracting a copper/tin source material from an oxalate of copper and/or tin is provided in Example 4, including an alkaline solution-based reaction tank 2, a heat exchanger 9, four standard chemical reaction tanks 3, two washing tanks 4, eight solid-liquid separators 5, five temporary storage tanks 6, seven impeller stirrers 7, two liquid flow pump pipe stirrers 8, a tail gas treatment unit 10, fourteen sensors 11, an automatic detection and feeding controller 12, a chemical immersion tin production line 32, an acidic tin electroplating production line 55, a metallic tin block 38, tin plating components 39, and a plurality of valves and pumps.

The alkaline solution-based reaction tank 2 is connected to a solid-liquid separator 5-1, and the solid-liquid separator 5-1 is connected to a temporary storage tank 6-1. The temporary storage tank 6-1 is configured to load a filter residue separated by the solid-liquid separator 5-1.

A standard chemical reaction tank 3-1 is connected to a standard chemical reaction tank 3-2 through a solid-liquid separator 5-2, and the standard chemical reaction tank 3-2 is connected to a temporary storage tank 6-4 through a solid-liquid separator 5-3. The temporary storage tanks 6-3 and 6-4 are configured to load filter residues separated by solid-liquid separators 5-2 and 5-3, respectively.

A washing tank 4-1 is connected to a solid-liquid separator 5-4, and then connected to a temporary storage tank 6-6. A washing tank 4-2 is connected to a solid-liquid separator 5-5, and then connected to a temporary storage tank 6-6.

The standard chemical reaction tank 3-3 is connected to the chemical immersion tin production line 32 through a solid-liquid separator 5-6 for circulation. The acidic tin electroplating production line 55 is connected to a standard chemical reaction tank 3-4.

The alkaline solution-based reaction tank 2 is provided with an impeller stirrer 7-1 and a plurality of sensors, including a sensor 11-1 as a pH meter and a sensor 11-2 as a thermometer.

The standard chemical reaction tank 3-1 is provided with an impeller stirrer 7-2 and a plurality of sensors, including a sensor 11-3 as a liquid level meter, a sensor 11-4 as a gravimeter, and a sensor 11-5 as a pH meter. The liquid level meter is configured to control an amount of water fed and a liquid level of a reaction solution. The gravimeter is configured to control an amount of a mixture of crude stannous hydroxide 19 and crude cupric hydroxide 20 fed. The pH meter is configured to control an amount of an acidic or alkaline substance fed to make stannous oxide and cupric oxide dissolved and make stannous hydroxide precipitated from a reaction solution. The standard chemical reaction tank 3-2 is configured to precipitate cupric hydroxide 20 through a reaction. The standard chemical reaction tank 3-3 is configured to prepare the traditional common immersion tin plating solution 29. The standard chemical reaction tank 3-4 is configured to prepare the traditional common acidic tin electroplating solution 31.

The washing tank 4-1 is configured to wash stannous hydroxide 19, and the washing tank 4-2 is configured to wash stannous hydroxide twice.

The solid-liquid separators 5-1, 5-2, and 5-3 are filter presses, the solid-liquid separator 5-4 is a centrifuge equipped with a scraper, and the solid-liquid separators 5-5, 5-6, 5-7, 5-8, and 5-9 are filters.

The chemical immersion tin production line 32 is the traditional common chemical immersion tin line equipped with a heat exchanger 9-2, a gravimeter 11-11, and a liquid level meter 11-12.

The acidic tin electroplating production line 55 is an acidic tin electroplating production line in which an electrolysis anode is an insoluble anode and a gravimeter 11-13 and a liquid level meter 11-14 are provided. A tin plating component 39-1 is an immersion tin component on the chemical immersion tin production line 32, and a tin plating component 39-2 is a cathode tin-plating component on the acidic tin electroplating production line 55, and is specifically the metallic tin block 38.

The tail gas treatment unit 10 is configured to absorb and treat a polluting tail gas escaping from each tank. A spray solution for treating the tail gas is a sodium hydroxide solution.

Process parameters acquired by the twelve sensors on site are transmitted to the automatic detection and feeding controller 12 for processing, and the automatic detection and feeding controller 12 outputs a control signal to execute a pre-programmed operating procedure, thereby enabling the apparatus to run automatically.

The standard chemical reaction tanks 3-3 and 3-4 are provided with sensors 11-9 and 11-10, respectively, which are both a gravimeter configured to control the addition of stannous hydroxide 23-2 during the preparation of a plating solution.

A substance to be treated in this example is a solid mixture 14 of cupric oxalate and stannous oxalate. An alkaline solution 28-1 is a potassium hydroxide solution, and an alkaline solution 28-2 is a sodium hydroxide solution. An acidic solution 27 is sulfuric acid. Other raw materials 40 for preparing the chemical immersion tin plating solution are the additive thiourea and other additive raw materials in the prior art. Other raw materials 42 for preparing the acidic tin electroplating solution are sulfuric acid and an additive raw material in the prior art.

In this example, a method for extracting a copper/tin source material from an oxalate of copper and/or tin is provided, including the following steps:

1. A power supply of the apparatus was turned on to make the automatic detection and feeding controller 12 run.

2. 20 kg of the solid mixture 14 of cupric oxalate and stannous oxalate was fed into the alkaline solution-based reaction tank 2 with a specified amount of water. On-site data detected by the pH meter and the thermometer was transmitted to the automatic detection and feeding controller 12 for processing. The feeding of the alkaline solution 28-1 into the alkaline solution-based reaction tank 2 was controlled through the pH meter to control a pH value of a reaction solution at 13.5. Simultaneously, a set value for the thermometer was 75° C., such that a temperature of the reaction solution was maintained at 75° C. through the heating by the heat exchanger 9-1. A reaction was conducted for 3 h to ensure that cupric oxalate and stannous oxalate salts in the reaction solution were completely converted into a precipitate including stannous oxide and cupric oxide.

3. The heat exchanger 9-1 and the impeller stirrer 7-1 in the alkaline solution-based reaction tank 2 were turned off, and a pump 46-1 was started to enable solid-liquid separation for a mixture in the alkaline solution-based reaction tank 2 to produce a filter residue A and a filtrate B. The filter residue A was a solid mixture of crude stannous oxide 21 and crude cupric oxide 22. The filtrate B was a salt-containing waste liquid 18.

4. The filter residue A was added to the standard chemical reaction tank 3-1 with the acidic solution 27 to completely dissolve the filter residue A. An amount of the filter residue A added was controlled by the gravimeter in this standard chemical reaction tank to achieve a set specific gravity value for a reaction solution. The addition of the alkaline solution 28-1 was controlled through the pH meter, and the addition of water and acidic and alkaline solutions was controlled through the liquid level meter. When a reading of the liquid level meter was within a controlled volume range and a reading of the pH meter was 3.0, it was considered as an endpoint for the precipitation of a stannous hydroxide precipitate in the reaction solution.

5. A pump 46-2 was started to enable solid-liquid separation for a mixture in the standard chemical reaction tank 3-1 to produce crude stannous hydroxide 19 as a filter residue and an acidic copper-containing filtrate. The acidic copper-containing filtrate was diverted to the standard chemical reaction tank 3-2.

6. The alkaline solution 28-1 was added to the standard chemical reaction tank 3-2 to adjust a pH value of a reaction solution to 7, such that cupric hydroxide 20 was precipitated from the reaction solution.

7. A pump 46-3 was started to enable solid-liquid separation for a mixture in the standard chemical reaction tank 3-2 to produce crude cupric hydroxide 20 and a salt-containing waste liquid 43-2. The crude cupric hydroxide 20 was stored in the temporary storage tank 6-4.

8. The crude stannous hydroxide 19 was transferred to the washing tank 4-1 and washed with water 33 to remove soluble impurities. The addition of the water was controlled through the liquid level meter in the washing tank. After the water-washing was completed, a pump 46-4 was started to transfer a mixture in the washing tank 4-1 to the solid-liquid separator 5-4 for solid-liquid separation to produce pure stannous hydroxide 23-1 and a washing waste liquid, namely, a salt-containing waste liquid 43-3.

9. The pure stannous hydroxide 23-1 was transferred to the washing tank 4-2 and washed twice with water. Filtration was conducted to produce pure stannous hydroxide 23-2.

10. The pure stannous hydroxide 23-2 was fed into the standard chemical reaction tank 3-3 under the control of the gravimeter in this standard chemical reaction tank to react with a return solution from the chemical immersion tin production line 32 for tin source replenishment. The replenishment of a tin source to the chemical immersion tin production line 32 by a pump 46-6 was controlled through the gravimeter in the chemical immersion tin production line 32 to ensure normal production. During this process, other raw materials 40 for preparing the immersion tin plating solution were added for plating solution maintenance.

11. The pure stannous hydroxide 23-2 was fed into the standard chemical reaction tank 3-4 to react with an acidic electroplating solution returned from the acidic tin electroplating production line 55 for tin source replenishment. A tin concentration in the acidic electroplating solution was controlled through the gravimeter. The feeding by a pump 46-7 was controlled to maintain normal production.

12. A polluting tail gas and a washing waste liquid generated were treated for environmental protection.

13. A running process of the apparatus was implemented with the automatic detection and feeding controller 12 according to pre-programmed procedures.

Through the above steps and with the apparatus shown in FIG. 4, a mixture of stannous oxalate and cupric oxalate could be prepared from a tin-containing and copper-containing mixed waste liquid, and then a tin source material in the mixture could be recycled. In this example, a crude tin bar 38 was deposited at a cathode of the acidic tin electroplating production line. The crude tin bar could be heated and melted, and casted into a tin block or tin ball with an appropriate size to serve as a metallic tin soluble anode.

### Example 5

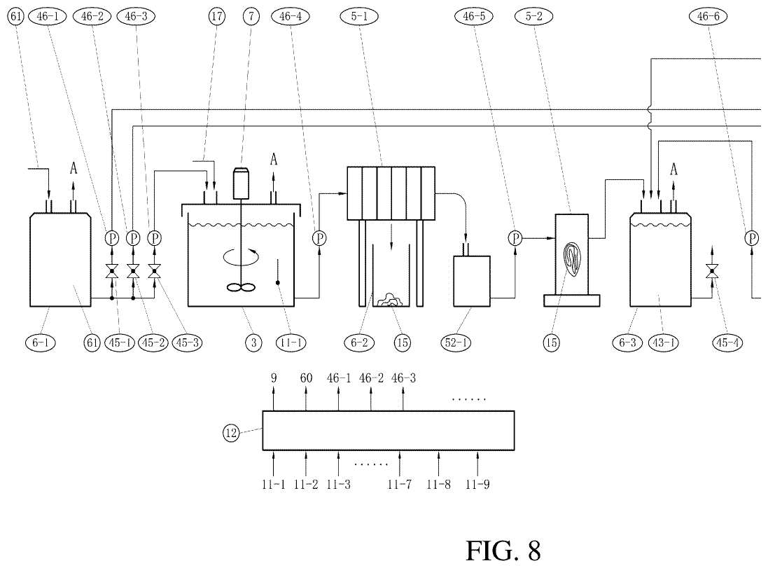

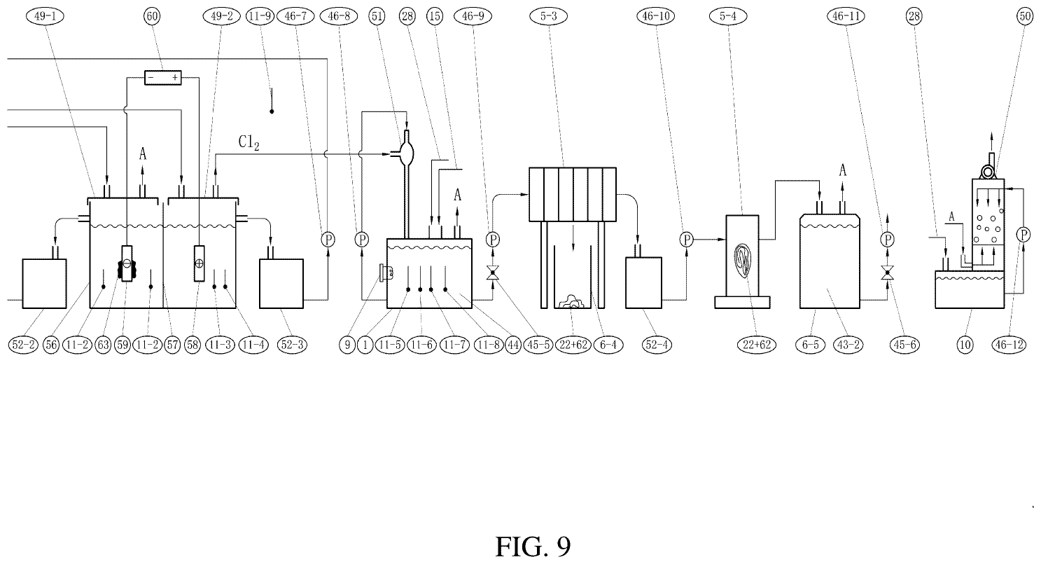

As shown in FIG. 8 and FIG. 9, an apparatus for extracting a copper/tin source material from an oxalate of copper and/or tin is provided in Example 5, including a hypochlorite-based reaction tank 1, a standard chemical reaction tank 3, four solid-liquid separators 5, seven temporary storage tanks 6, a heat exchanger 9, a tail gas treatment unit 10, eight sensors 11, an automatic detection and feeding controller 12, a spray tower 50, a vacuum ejector 51, an electrolytic cell 56, a separator 57, an electrolysis anode 58, an electrolysis cathode 59, and an electrolytic power supply 60.

The electrolytic cell 56 is an electrolytic cell provided with a separator to divide the electrolytic cell into an anode compartment and a cathode compartment. The electrolysis anode 58 is a titanium-based coated anode, the electrolysis cathode 59 is a copper plate, and the separator is a cation-exchange membrane. The anode compartment and the cathode compartment are connected to a temporary storage tank 6-3 through an overflow buffer tank. The anode compartment is further connected through a gas pipeline to the vacuum ejector 51 arranged in the hypochlorite-based reaction tank 1.

A temporary storage tank 6-1 is configured to temporarily store a spent acidic cupric chloride etching solution, and is connected to the standard chemical reaction tank 3 and the anode compartment and the cathode compartment of the electrolytic cell 56.

The standard chemical reaction tank 3 is connected to the temporary storage tank 6-3 through a solid-liquid separator 5-1, an overflow buffer tank 52-1, and a solid-liquid separator 5-2. The temporary storage tank 6-2 is configured to load a filter residue separated by the solid-liquid separator 5-1.

In the hypochlorite-based reaction tank 1, chlorine is introduced to react with a sodium hydroxide solution to produce sodium hypochlorite, and the sodium hypochlorite, as an oxidizing agent, undergoes a chemical reaction with cupric oxalate 15. The hypochlorite-based reaction tank 1 is connected to a temporary storage tank 6-5 through a solid-liquid separator 5-3, an overflow buffer tank 52-4, and a solid-liquid separator 5-4.

The solid-liquid separators 5-1 and 5-3 are filter presses, and the solid-liquid separators 5-2 and 5-4 are filters.

A sensor 11-1 is a liquid level meter, and this liquid level meter is configured to control a liquid level of a reaction solution in the standard chemical reaction tank 3. A sensor 11-2 is a gravimeter arranged in the cathode compartment, and this gravimeter is configured to control the addition of a spent acidic cupric chloride etching solution 61 to the cathode compartment. A sensor 11-3 is a gravimeter arranged in the anode compartment, and this gravimeter is configured to control the addition of a spent acidic cupric chloride etching solution 61 to the anode compartment. A sensor 11-4 is an ORP meter arranged in the anode compartment, and the ORP meter is configured to enable safety interlocking for the electrolytic power supply 60. A sensor 11-5 is a liquid level meter, a sensor 11-6 is a pH meter, a sensor 11-7 is an ORP meter, and a sensor 11-8 is a thermometer, which are all arranged in the hypochlorite-based reaction tank 1. A sensor 11-9 is an ambient chlorine gas concentration detector at a work site. The pH meter 11-6 is configured to control the addition of a potassium hydroxide solution. The ORP meter 11-7 is configured to control a working current or a shutdown of the electrolytic power supply. The thermometer 11-8 is configured to control a working temperature of a reaction solution.

Process parameters acquired by the sensors on site are transmitted to the automatic detection and feeding controller 12 for processing, and the automatic detection and feeding controller 12 outputs a control signal to execute a pre-programmed operating procedure, thereby enabling the apparatus to run automatically.

An alkaline solution 28 adopted in this example is a potassium hydroxide solution, which also serves as a pH adjusting agent. Cupric oxalate 15 to be treated is produced from a reaction of a spent acidic cupric chloride etching solution 61 with oxalic acid 17.

The tail gas treatment unit 10 adopts the potassium hydroxide solution 28 as a tail gas-absorbing reaction solution.

Anode and cathode electrolytes in the electrolytic cell 56 are both the spent acidic cupric chloride etching solution 61. The spent acidic cupric chloride etching solution is a mixed solution with hydrochloric acid, cupric chloride, and a chloride salt as main components. A concentration of copper ions in the spent acidic cupric chloride etching solution is 130 g/L.

In this example, a method for extracting a copper/tin source material from an oxalate of copper and/or tin is provided, including the following steps:

1. A power supply of the apparatus was turned on to make the automatic detection and feeding controller 12 run.

2. Pumps 46-1, 46-2, and 46-3 were started to feed the spent acidic cupric chloride etching solution 61 into the standard chemical reaction tank 3 and the anode and cathode compartments of the electrolytic cell, and to feed the potassium hydroxide solution into the hypochlorite-based reaction tank 1.

3. An impeller stirrer 7 was started. A specified amount of the oxalic acid 17 was fed into the standard chemical reaction tank 3 with a specified amount of the spent acidic cupric chloride etching solution, and a reaction was conducted to produce cupric oxalate 15.

4. A solid-liquid mixture in the standard chemical reaction tank 3 was subjected to solid-liquid separation by the solid-liquid separator 5-1 and the solid-liquid separator 5-2 to produce cupric oxalate 15 and a hydrochloric acid-containing filtrate 43-1. The cupric oxalate was temporarily stored in the temporary storage tank 6-2. The hydrochloric acid-containing filtrate was diverted to the temporary storage tank 6-3 for temporary storage.

5. The electrolytic cell was started through the automatic detection and feeding controller 12, such that chlorine was evolved at the anode and copper was deposited at the cathode. The chlorine evolved was directed to the hypochlorite-based reaction tank 1 to participate in a reaction. During the reaction, the heat exchanger 9 in the hypochlorite-based reaction tank was started to control a reaction solution at 60° C. The addition of the potassium hydroxide solution was controlled through the pH meter to maintain a pH value of the reaction solution at 14. ORP of the reaction solution was controlled at 100 mV through the ORP meter. 20 kg of the cupric oxalate was divided into small portions and added separately to the hypochlorite-based reaction tank 1 in multiple batches, and a reaction was conducted for 9 h, such that the cupric oxalate 15 was oxidized into cupric oxide and a trace amount of sodium cuprate.

6. A solid-liquid mixture produced after the reaction in the hypochlorite-based reaction tank 1 was subjected to solid-liquid separation with the filter press 5-3 and the filter 5-4 to produce a mixture of cupric oxide and a trace amount of sodium cuprate as a filter residue and a salt-containing waste liquid 43-2 as a filtrate. The filter residue was temporarily stored in the temporary storage tank 6-4. The filtrate was diverted to the temporary storage tank 6-5 for a later treatment.

7. A running process of the apparatus was implemented by the automatic detection and feeding controller 12 according to pre-programmed procedures. An ambient chlorine gas concentration in a workshop was monitored by the chlorine gas concentration detector 11-9.

Through the above seven steps, the cupric oxalate was converted into a cupric oxide product including sodium cuprate through a chemical reaction. In the method, the electrolysis of a spent acidic cupric chloride etching solution for copper extraction was used to optimize the method for energy conservation and emission reduction.

During the above production, the hydrochloric acid-containing waste liquid 43-1 could be used as a raw material to prepare a regenerated etching replenisher according to the preparation requirements for an acidic cupric chloride etching replenisher, and then the regenerated etching replenisher was recycled in an etching production line. Additionally, the cupric oxide product included a trace amount of sodium cuprate, which could be decomposed by heating with water or removed by adding a reducing agent.

### Example 6

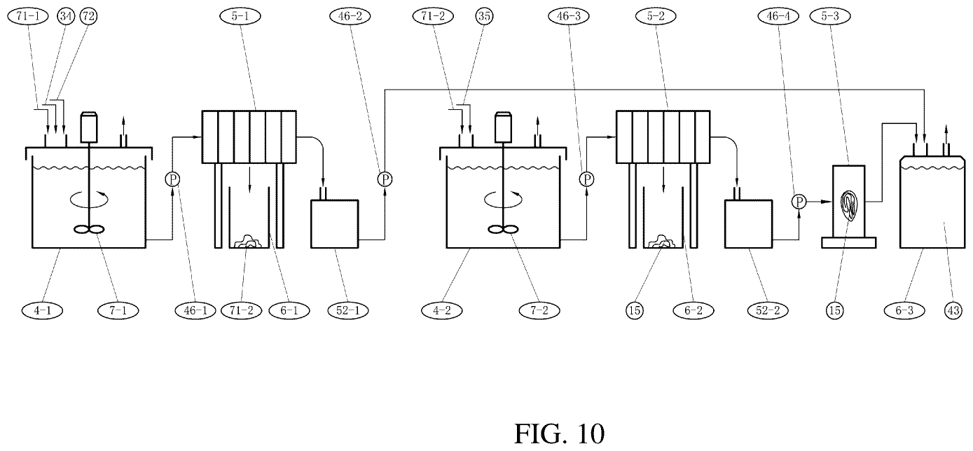

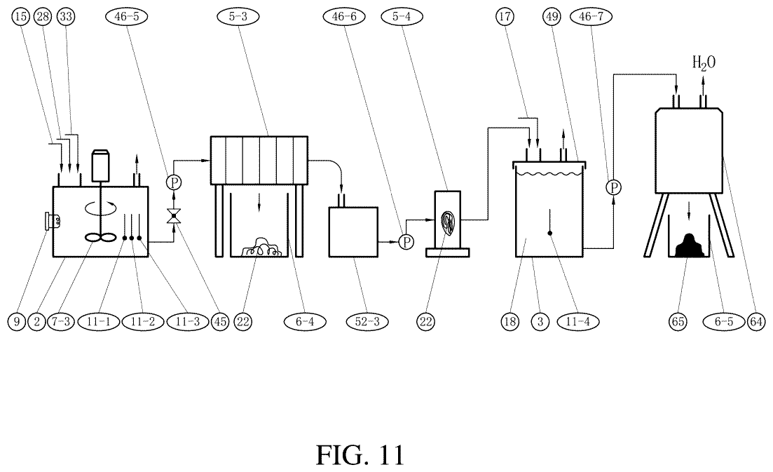

As shown in FIG. 10 and FIG. 11, an apparatus for extracting a copper/tin source material from an oxalate of copper and/or tin is provided in Example 6, including an alkaline solution-based reaction tank 2, a standard chemical reaction tank 3, two washing tanks 4, five solid-liquid separators 5, four temporary storage tanks 6, three impeller stirrers 7, a heat exchanger 9, a plurality of sensors 11, three overflow buffer tanks 52, an evaporator 64, and a plurality of valves and pumps.

Washing tanks 4-1 and 4-2 are configured to enable acid-washing for iron impurity-containing cupric oxalate 71-1 to remove an iron impurity to produce pure cupric oxalate 15.

The alkaline solution-based reaction tank 2 is connected to a solid-liquid separator 5-3, and is further connected to an overflow buffer tank 52-3 through a liquid pipeline. A temporary storage tank 6-4 is configured to load a filter residue separated by the solid-liquid separator 5-3. The overflow buffer tank 52-3 is connected to the standard chemical reaction tank 3 through a solid-liquid separator 5-4, and then is connected to the evaporator 64. A temporary storage tank 6-5 is configured to load a solid product from the evaporator 64.

The alkaline solution-based reaction tank 2 is provided with an impeller stirrer 7-3, a heat exchanger 9, and a plurality of sensors. A sensor 11-1 is a liquid level meter, a sensor 11-2 is a thermometer, and a sensor 11-3 is a pH meter. The heat exchanger 9 is configured to heat a reaction solution in the alkaline solution-based reaction tank 2.

The solid-liquid separators 5-1, 5-2, and 5-3 are filter presses, and the solid-liquid separator 5-4 is a filter.

The evaporator 64 is configured to concentrate a potassium oxalate solution through evaporation to produce a potassium oxalate solid product.

A sensor 11-4 is a pH meter arranged in the standard chemical reaction tank 3.

A substance to be treated in this example is iron impurity-containing cupric oxalate 71. An alkaline solution 28 is a potassium hydroxide solution with a concentration of 30%.

In this example, a method for extracting a copper/tin source material from an oxalate of copper and/or tin is provided, including the following steps:

1. Iron impurity-containing cupric oxalate 71-1, hydrochloric acid 34, and hydrogen peroxide 72 were fed into the washing tank 4-1 for acid-washing. Solid-liquid separation was conducted with the filter press 5-1 to produce a filter residue 71-2 and a salt-containing waste liquid 43.

2. The filter residue 71-2 (which was primarily iron impurity-containing cupric oxalate) and sulfuric acid were fed into the washing tank 4-2 for further washing. Pressure filtration was conducted to produce cupric oxalate 15 and a salt-containing waste liquid 43. The salt-containing waste liquids 43 were diverted to the temporary storage tank 6-3 for temporary storage.

3. A specified amount of water and 20 kg of the cupric oxalate 15 were fed into the alkaline solution-based reaction tank 2. A sample was collected intermittently with the pH meter, and tested for pH after cooling. Based on a pH measurement result, the addition of the alkaline solution 28 was controlled to maintain a pH value of a reaction solution at more than 14. A working temperature of the reaction solution was controlled at 100° C. by the heat exchanger 9. The impeller stirrer 7 was started, and a chemical reaction was conducted for 1 h to produce a copper compound-containing precipitate, which was a cupric oxide powder.

4. After the reaction was completed, the heat exchanger 9 in the alkaline solution-based reaction tank 2 was started for cooling. A pump 46-1 was then started to enable solid-liquid separation for a reaction product in the alkaline solution-based reaction tank 2 by the solid-liquid separator 5-1 and the solid-liquid separator 5-2 to produce a filter residue A and a filtrate B. The filter residue A was crude cupric oxide 22. The filtrate B was a mixed solution of soluble potassium oxalate and potassium hydroxide. The filtrate B was diverted to the standard chemical reaction tank 3.

5. Based on a process set value of the pH meter in the standard chemical reaction tank 3, oxalic acid 17 was added to the standard chemical reaction tank 3 to undergo a neutralization reaction with the potassium hydroxide in the mixed solution. The addition of oxalic acid was stopped once a reading of the pH meter dropped to the process set value.

6. A potassium oxalate solution prepared in the standard chemical reaction tank 3 was transferred to the evaporator 64 and subjected to evaporative concentration to produce a potassium oxalate solid. The potassium oxalate solid was temporarily stored in the temporary storage tank 6-2.

Through the above steps, the iron impurity-containing cupric oxalate 71 was acid-washed and then converted into cupric oxide 22 and a potassium oxalate solid 65 through the chemical reaction in the approach 2 of the present disclosure.

### Example 7

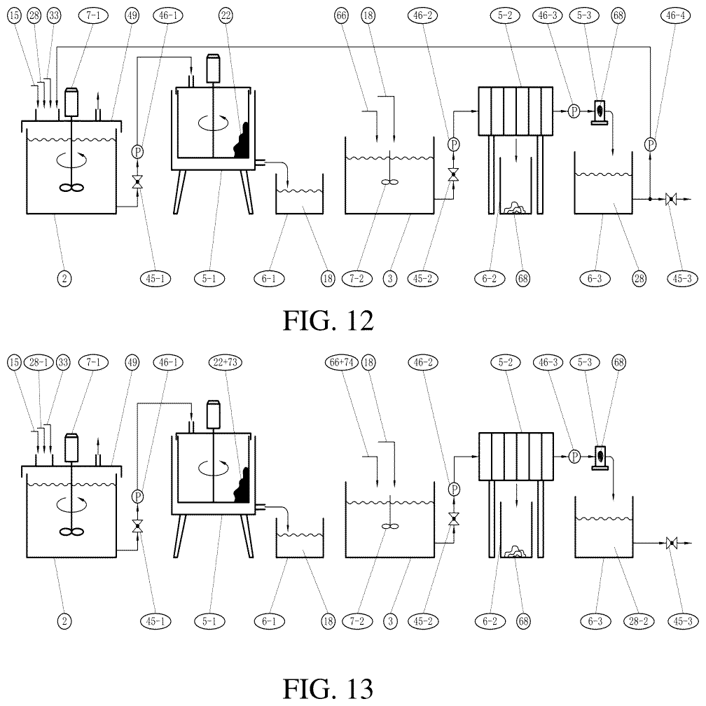

As shown in FIG. 12, an apparatus for extracting a copper/tin source material from an oxalate of copper and/or tin is provided in Example 7 of the present disclosure, including an alkaline solution-based reaction tank 2, a standard chemical reaction tank 3, three solid-liquid separators 5, three temporary storage tanks 6, two impeller stirrers, a valve, and a pump.

The alkaline solution-based reaction tank 2 is connected to a solid-liquid separator 5-1 and a temporary storage tank 6-1 successively. A washing tank 4 is connected to solid-liquid separators 5-2 and 5-3 successively. A temporary storage tank 6-2 is configured to receive a filter residue from the solid-liquid separator 5-2. A temporary storage tank 6-3 is connected to the solid-liquid separator 5-3 to receive a filtrate. The temporary storage tank 6-3 is further connected to the alkaline solution-based reaction tank 2.

The solid-liquid separator 5-1 is a centrifuge, the solid-liquid separator 5-2 is a filter press, and the solid-liquid separator 5-3 is a filter.

A substance to be treated is cupric oxalate.

An alkaline solution 28 adopted in this example is a potassium hydroxide solution.

In this example, a method for extracting a copper/tin source material from an oxalate of copper and/or tin is provided, including the following steps:

1. A specified amount of water and 20 kg of cupric oxalate 15 were added to the alkaline solution-based reaction tank 2. Then, the alkaline solution 28 was added until a weight of an alkaline substance was more than 1.5 times an equivalent amount required to react with the cupric oxalate. The impeller stirrer 7-1 was started, and a chemical reaction was conducted for 24 h at room temperature to produce a copper compound-containing precipitate, which was crude cupric oxide 22.

2. The pump 46-1 was started to enable solid-liquid separation for a reaction product in the alkaline solution-based reaction tank 2 by the solid-liquid separator 5-1 to produce a filter residue A and a filtrate B. The filter residue A was crude cupric hydroxide 20. The filtrate B was primarily a soluble oxalate-containing solution 18. The filtrate B was diverted to the temporary storage tank 6-1 for temporary storage.

3. Calcium hydroxide was allowed to react with the soluble oxalate-containing solution 18 in a standard chemical reaction tank 3 to produce a solid-liquid mixture of calcium oxalate and potassium hydroxide. Solid-liquid separation was conducted by the solid-liquid separators 5-2 and 5-3 to produce calcium oxalate 68 and an alkaline solution 28.

4. The alkaline solution 28 (which was specifically a solution with potassium hydroxide as a main component) was used for the next round of cupric oxalate treatment.

Through the above steps, the cupric oxalate was converted into a cupric oxide product through the chemical reaction in the approach 2 of the present disclosure. In addition, calcium hydroxide was allowed to react with the solution 18 mainly including potassium oxalate to produce a calcium oxalate precipitate and a potassium hydroxide solution, and solid-liquid separation was conducted to collect the potassium hydroxide solution 28 for recycling.

### Example 8

As shown in FIG. 13, an apparatus is provided in this example, including an alkaline solution-based reaction tank 2, a standard chemical reaction tank 3, three solid-liquid separators 5, three temporary storage tanks 6, and two impeller stirrers. The apparatus in this example is similar to the apparatus in FIG. 7, except that a temporary storage tank 6-3 is not connected to the alkaline solution-based reaction tank 2.

This example adopts the same steps as Example 7, except that:

An alkaline solution 28-1 added to the alkaline solution-based reaction tank 2 was a mixed solution of potassium hydroxide and sodium hydroxide. An alkaline solution 28-2 in a temporary storage tank 6-2 was a mixed solution of potassium hydroxide, sodium hydroxide, potassium carbonate, sodium carbonate, sodium bicarbonate, and potassium bicarbonate.

The alkaline substance solid 74 was calcium carbonate and calcium bicarbonate.

When the alkaline solution 28 was added in the step 1, a weight of the alkaline substance was larger than an equivalent amount required to react with the cupric oxalate, and a concentration of sodium ions in a reaction solution was 2 mol/L. During a reaction, the cupric oxalate fully participated in the reaction to produce a co-precipitate of cupric oxide and sodium oxalate.

After the solid-liquid separation in the step 2, a resulting filter residue was a mixture of cupric oxalate and sodium oxalate, and a resulting filtrate 18 was a mixed solution of potassium oxalate, sodium oxalate, potassium hydroxide, and sodium hydroxide. The filter residue, namely, the mixture of cupric oxalate and sodium oxalate, was washed with water to remove the sodium oxalate.

In the step 3, the filtrate 18 was allowed to react with a mixture of calcium hydroxide, calcium carbonate, and calcium bicarbonate in the standard chemical reaction tank 3. After solid-liquid separation, a calcium oxalate precipitate and a mixed solution 28-2 including potassium hydroxide, potassium carbonate, potassium bicarbonate, sodium hydroxide, sodium carbonate, and sodium bicarbonate were produced. The mixed solution was temporarily stored in the temporary storage tank 6-2.

### Example 9

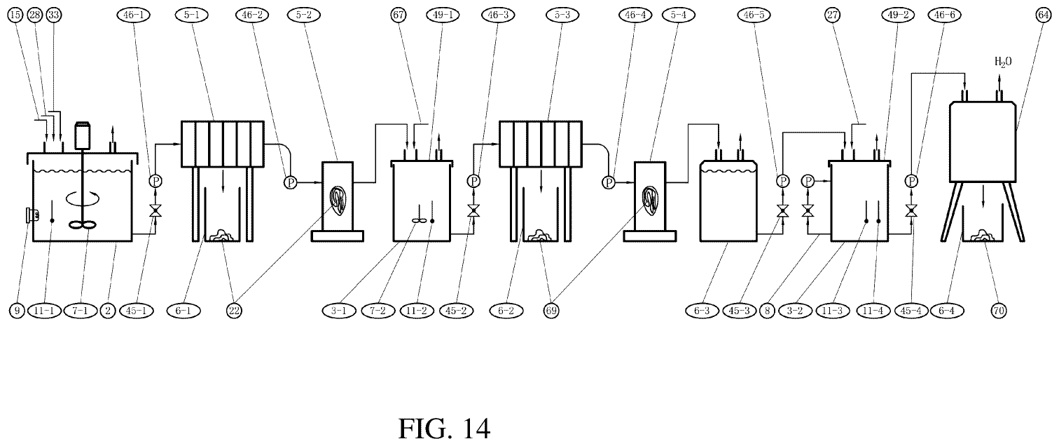

As shown in FIG. 14, an apparatus for extracting a copper/tin source material from an oxalate of copper and/or tin is provided in the present disclosure, including an alkaline solution-based reaction tank 2 with a heater, two standard chemical reaction tanks 3, four solid-liquid separators 5, four temporary storage tanks 6, two impeller stirrers 7, an evaporator 64, and a plurality of valves and pumps.

In the apparatus of this example, the alkaline solution-based reaction tank 2, a solid-liquid separator 5-1, a solid-liquid separator 5-2, a standard chemical reaction tank 3-1, a solid-liquid separator 5-3, a solid-liquid separator 5-4, a temporary storage tank 6-3, a standard chemical reaction tank 3-2, and the evaporator 64 are connected sequentially. Temporary storage tanks 6-1 and 6-2 are configured to receive filter residues from the solid-liquid separators 5-1 and 5-3, respectively. A temporary storage tank 6-4 is configured to load a solid product from the evaporator 64.

The solid-liquid separators 5-1 and 5-3 are filter presses, and the solid-liquid separators 5-2 and 5-4 are filters.

A substance to be treated is cupric oxalate 15.

An acidic solution 27 is sulfuric acid.

An alkaline solution 28 adopted in this example is a potassium hydroxide solution.

A sensor 11-1 is a thermometer arranged in the alkaline solution-based reaction tank 2. A sensor 11-2 is a pH meter arranged in the standard chemical reaction tank 3-1. A sensor 11-3 is a liquid level meter and a sensor 11-4 is a pH meter, which are arranged in the standard chemical reaction tank 3-2.

During an operation process, ferrous sulfate 67 is used as a raw material to produce potassium sulfate and ferrous oxalate products. The evaporator 64 is configured to enable evaporation for a potassium sulfate solution.

In this example, a method for extracting a copper/tin source material from an oxalate of copper and/or tin is provided, including the following steps:

1. A specified amount of water and 20 kg of cupric oxalate 15 were added to the alkaline solution-based reaction tank 2. Then, the alkaline solution 28 was added until a weight of an alkaline substance was more than 1.1 times an equivalent amount required to react with the cupric oxalate. The impeller stirrer 7-1 was started, and a chemical reaction was conducted for 6 h at 70° C. to produce a copper compound-containing precipitate, which was crude cupric oxide 22.

2. The pump 46-1 was started to enable solid-liquid separation for a reaction product in the alkaline solution-based reaction tank 2 by the solid-liquid separators 5-1 and 5-2 to produce a filter residue A and a filtrate B. The filter residue A was crude cupric oxide 22. The filtrate B was primarily a soluble oxalate-containing solution 18. The filtrate B was diverted to the standard chemical reaction tank 3-1 for a subsequent chemical reaction. The cupric oxide was temporarily stored in the temporary storage tank 6-1.

3. Under the control of a pH meter, ferrous sulfate was fed into the standard chemical reaction tank 3-1 to react with the mixed solution of potassium oxalate and potassium hydroxide to produce a solid-liquid mixture including ferrous oxalate, potassium sulfate, and potassium hydroxide.

4. The solid-liquid mixture produced after a reaction in the standard chemical reaction tank 3-1 was subjected to solid-liquid separation by the solid-liquid separators 5-3 and 5-4 to produce ferrous oxalate as a filter residue and a mixed solution of potassium sulfate and potassium hydroxide as a filtrate.

5. The ferrous oxalate was temporarily stored in the temporary storage tank 6-2. A filtrate from the solid-liquid separator 5-4 was diverted to the temporary storage tank 6-3 for temporary storage.

6. Under the control of the liquid level meter, a solution in the temporary storage tank 6-3 was fed into the standard chemical reaction tank 3-2. Under the control of the pH meter, sulfuric acid was fed for a neutralization reaction to produce a pure potassium sulfate solution.

7. The potassium sulfate solution in the standard chemical reaction tank 3-2 was transferred to the evaporator 64, and subjected to evaporative crystallization to produce a potassium sulfate solid 70, which was temporarily stored in the temporary storage tank 6-4.

Through the above steps, the cupric oxalate 15 was converted into a cupric oxide product through the chemical reaction in the approach 2 of the present disclosure. In addition, ferrous sulfate was allowed to react with the potassium oxalate solution to produce a ferrous oxalate product and a potassium sulfate product.

What is claimed is:

1. A method for extracting a copper/tin source material from an oxalate of copper and/or tin, comprising following steps:
(1) treating the oxalate of copper and/or tin using at least one of following approaches:
approach 1: allowing cupric oxalate and/or stannous oxalate to undergo a chemical reaction with a hypochlorite in a hypochlorite-containing aqueous solution to produce a copper compound-containing and/or tin compound-containing precipitate, which is accompanied by release of carbon dioxide; and
approach 2: allowing the cupric oxalate and/or the stannous oxalate to undergo a chemical reaction in a solution comprising an alkaline substance to produce a copper compound-containing and/or tin compound-containing precipitate, wherein the alkaline substance comprises a potassium-containing alkaline substance; and
(2) subjecting a solid-liquid mixture produced after the chemical reaction in the step (1) to solid-liquid separation to produce a filter residue A and a filtrate B, wherein the filter residue A is the copper compound-containing and/or tin compound-containing precipitate.

2. The method for extracting a copper/tin source material from an oxalate of copper and/or tin according to claim 1, wherein the hypochlorite is sodium hypochlorite and/or potassium hypochlorite; and the potassium-containing alkaline substance is one or more selected from the group consisting of potassium hydroxide, potassium carbonate, and potassium bicarbonate.

3. The method for extracting a copper/tin source material from an oxalate of copper and/or tin according to claim 2, wherein the stannous oxalate is produced from a reaction of a tin-containing waste liquid with oxalic acid or a reaction of oxalic acid with a filtrate produced by filtering the tin-containing waste liquid to remove a stannic oxide solid; and the cupric oxalate is produced from a reaction of a copper-containing waste liquid with oxalic acid.

4. The method for extracting a copper/tin source material from an oxalate of copper and/or tin according to claim 3, wherein in the approach 1, when a copper compound-containing precipitate is composed mainly of cupric hydroxide, a pH of a reaction solution is controlled in a range of 3.5≤pH≤8.5 during the chemical reaction; and when the copper compound-containing precipitate is composed mainly of cupric oxide, the pH of the reaction solution is controlled at 10 or higher during the chemical reaction.

5. The method for extracting a copper/tin source material from an oxalate of copper and/or tin according to claim 4, wherein in the approach 1, an oxidation-reduction potential (ORP) meter is used to control addition of the hypochlorite, or a pH meter and the ORP meter are used to control addition of a pH adjusting agent and the hypochlorite, respectively, such that the reaction solution undergoes the chemical reaction in a direction of generating a process-defined target product under stably-controlled parameters; and the pH adjusting agent is preferably one or more selected from the group consisting of sodium hydroxide, potassium hydroxide, sodium carbonate, potassium carbonate, sodium bicarbonate, and potassium bicarbonate.

6. The method for extracting a copper/tin source material from an oxalate of copper and/or tin according to claim 5, wherein in the approach 2 of the step (1), the alkaline substance is either the potassium-containing alkaline substance alone or a mixture of the potassium-containing alkaline substance and a sodium-containing alkaline substance.

7. The method for extracting a copper/tin source material from an oxalate of copper and/or tin according to claim 6, wherein in the approach 2 of the step (1), when the mixture of the potassium-containing alkaline substance and the sodium-containing alkaline substance is used in the chemical reaction, a concentration of a sodium ion in a reaction solution does not exceed 2 mol/L.

8. The method for extracting a copper/tin source material from an oxalate of copper and/or tin according to claim 7, wherein the alkaline substance is potassium hydroxide.

9. The method for extracting a copper/tin source material from an oxalate of copper and/or tin according to claim 8, wherein in the approach 2, a reaction temperature of the reaction solution is controlled in a range of 30° C. to 100° C., and/or a pH of the reaction solution is adjusted to 10 or more during the chemical reaction.

10. The method for extracting a copper/tin source material from an oxalate of copper and/or tin according to claim 9, wherein in the step (1), when the oxalate participating in the reaction is a mixture of the stannous oxalate and the cupric oxalate, to separate a copper compound and a tin compound in the filter residue A, the filter residue A is first dissolved in an acidic solution to produce an acidic mixed solution comprising a tin salt and a copper salt; an alkaline compound is added to the acidic mixed solution comprising the tin salt and the copper salt to adjust a pH to control precipitation of a stannous hydroxide solid based on a low pH for precipitation of stannous hydroxide, and the stannous hydroxide solid is separated from a resulting acidic copper salt-containing solution through solid-liquid separation; and the alkaline compound is further added to the acidic copper salt-containing solution to produce a cupric hydroxide and/or cupric oxide precipitate, and solid-liquid separation is conducted to obtain a cupric hydroxide and/or cupric oxide-containing filter residue;
the acidic solution is a solution comprising at least one selected from the group consisting of hydrochloric acid, sulfuric acid, and formic acid; and the alkaline compound is at least one selected from the group consisting of sodium hydroxide, sodium carbonate, sodium bicarbonate, potassium hydroxide, potassium carbonate, and potassium bicarbonate.

11. The method for extracting a copper/tin source material from an oxalate of copper and/or tin according to claim 10, wherein when the approach 2 in the step (1) is adopted, the filtrate B obtained in the step (2) is mixed with a compound comprising at least one selected from the group consisting of calcium, manganese, zinc, and ferrous iron for a reaction to produce a desired oxalate product.

12. The method for extracting a copper/tin source material from an oxalate of copper and/or tin according to claim 11, wherein in the step (1), a pH of a reaction solution for treating the stannous oxalate is lower than or equal to 14 to avoid generation of a soluble stannate.

13. The method for extracting a copper/tin source material from an oxalate of copper and/or tin according to claim 12, wherein a hypochlorite solution is prepared by introducing chlorine generated from electrolysis of a spent acidic etching solution into an alkaline solution, and used in the chemical reaction of the approach 1 in the step (1).

14. The method for extracting a copper/tin source material from an oxalate of copper and/or tin according to claim 13, wherein the cupric oxalate is first directly added to a reaction tank with the alkaline solution for producing the hypochlorite, an amount of the chlorine introduced into the reaction tank is controlled by an ORP meter arranged in the reaction tank, and an amount of the alkaline compound is controlled to maintain a desired pH value of a reaction solution, such that a reaction product is primarily cupric oxide to produce a cupric oxide powder product.

15. The method for extracting a copper/tin source material from an oxalate of copper and/or tin according to claim 14, wherein a cupric oxalate precipitate produced from a reaction of an iron-containing acidic etching solution with oxalic acid is washed with hydrochloric acid and/or sulfuric acid at least once to remove iron.

16. An apparatus for extracting a copper/tin source material from an oxalate of copper and/or tin with the method according to claim 1, comprising: at least one hypochlorite-based reaction tank and/or at least one alkaline solution-based reaction tank, and at least one solid-liquid separator,
wherein the at least one hypochlorite-based reaction tank is configured to enable the chemical reaction of the cupric oxalate and/or the stannous oxalate with the hypochlorite in the step (1) to produce stannous hydroxide and/or cupric hydroxide and/or cupric oxide; the at least one alkaline solution-based reaction tank is configured to enable the chemical reaction of the cupric oxalate and/or the stannous oxalate with a solution comprising the potassium-containing alkaline substance in the step (1) to produce stannous oxide and/or cupric oxide; and the at least one solid-liquid separator is configured to enable the solid-liquid separation for the solid-liquid mixture.

17. The apparatus for extracting a copper/tin source material from an oxalate of copper and/or tin according to claim 16, wherein the alkaline solution-based reaction tank is provided with a heat exchanger configured to enable the chemical reaction of the cupric oxalate and/or the stannous oxalate with the solution comprising the potassium-containing alkaline substance under heating to rapidly produce the stannous oxide and/or the cupric oxide.

18. The apparatus for extracting a copper/tin source material from an oxalate of copper and/or tin according to claim 17, wherein the at least one hypochlorite-based reaction tank is further provided with a pH meter and/or an ORP meter to make a reaction proceed in a direction of generating a target product.

19. The apparatus for extracting a copper/tin source material from an oxalate of copper and/or tin according to claim 18, wherein a washing tank is further provided to wash iron-containing cupric oxalate and/or a filter residue comprising a compound of copper and/or tin produced after a reaction;
a temporary storage tank is further provided to temporarily store a material;
a standard chemical reaction tank is further provided to prepare a solution;
an overflow buffer tank is further provided to address issues caused by an unsmooth liquid flow between tanks in the apparatus; and
an electric furnace is further provided to oven-dry a powdered product produced after the solid-liquid separation.

20. The apparatus for extracting a copper/tin source material from an oxalate of copper and/or tin according to claim 19, wherein a stirrer is further provided for the at least one hypochlorite-based reaction tank and/or the at least one alkaline solution-based reaction tank and/or the standard chemical reaction tank to thoroughly stir a solution; and
a heat exchanger is further provided for the at least one hypochlorite-based reaction tank and/or the standard chemical reaction tank to control a reaction solution at a desired temperature.
